(19) United States
(12) Patent Application Publication
(10) Pub. No.: US 2023/0151616 A1
(43) Pub. Date: May 18, 2023

(54) COVERING SYSTEM FOR A FLOOR, A WALL AND/OR A CEILING

(71) Applicant: FLOORING TECHNOLOGIES LTD., Ricasoli, Kalkara (MT)

(72) Inventor: Sebastian DICKE, Bantikow (DE)

(21) Appl. No.: 17/916,335

(22) PCT Filed: Apr. 8, 2021
(86) PCT No.: PCT/EP2021/059216

§ 371 Date: Sep. 30, 2022

(30) Foreign Application Priority Data
Apr. 8, 2020 (WO) 20168759.7

(51) Int. Cl. E04F 13/072; B32B 3/06; B32B 27/36; B32B 27/18; B32B 27/10; E04F 13/08; E04F 15/02; H02G 3/04

(52) U.S. Cl. CPC E04F 13/072; B32B 3/06; B32B 27/365; B32B 27/18; B32B 27/10; E04F 13/0866; E04F 13/0869; E04F 13/0871; E04F 15/02016; H02G 3/0418; B32B 2471/00; B32B 2607/02; B32B 2419/00; B32B 2451/00; B32B 2307/202; B32B 2307/206; B32B 2307/412; B32B 2307/584; B32B 2264/1023; B32B 2307/102; B32B 2307/4023; E04F 2201/023; E04F 2290/023; E04F 2290/041; E04B 2103/04; E04F 13/0894; E04F 15/02038; F24D 13/024

(57) ABSTRACT

The disclosure relates to a covering system for a floor, a wall and/or a ceiling. The covering system includes a decorated side, a lower side opposite the decorated side and a plurality of interconnected covering elements. At least one conducting element is arranged between at least two of the covering elements in such a way that the at least one conducting element is at least partially visible on the decorated side. The at least one conducting element is configured to conduct a physical quantity, material or signals. The at least one conducting element includes an interface to a source or a consumer of the physical quantity, material or signals.

### FIELD OF INVENTION

The invention relates to a covering system for a floor, a wall and/or a ceiling, the covering system comprising a decorated side, a lower side opposite the decorated side, and a plurality of interconnected covering elements, wherein at least one conducting element is arranged between at least two of the covering elements in such a way that the at least one conducting element is at least partially visible on the decorated side.

### BACKGROUND

Such covering systems have been known from the prior art for many years and are used to cover floors, walls and/or ceilings. The individual covering elements are con-venient in size and can usually be interconnected, for example by engaging slots and springs provided on the side surfaces of the covering elements. This or other types of connecting elements are equipped with locking elements, so that the individual covering elements can be securely interconnected. This is particularly well-known from the prior art in the form of laminate panels.

EP 2 353 821 A1 discloses such locking elements. The two panels that form the covering elements are interconnected such that a gap remains between the two panels on the decorated side. A surface element or joint element, such as piping, is inserted in this gap. This can be seen on the decorated side and is used as a decorative element.

A decorative element is also known from EP 2 221 431 B1, which is arranged between the two panels, which also form the covering elements of the floor described in this document. In this design, it extends across the entire thickness of the floor covering to be produced, i.e. from the decorated side to the opposite side. It is arranged on specially provided connecting elements on a side surface of one of the panels. On the side facing away from this panel is the locking element, which is inserted into a slot arranged on a side surface of an adjacent panel.

EP 2 116 778 B1 describes a different covering system. A layer made of electrically conductive material is arranged on the lower side of the individual covering elements. The connecting elements between the individual covering elements are designed in such a way that, when the covering elements are connected to each other, an electrical connection is also established between the respective layers of electrically conductive material. The layers which, when installed, extend on the lower side of the entire floor, are later subjected to an electric current and can therefore be used as underfloor heating.

### SUMMARY OF INVENTION

The invention aims to further develop a covering system for a floor, a wall and/or a ceiling in such a way that various functions can be integrated into the covering system and the covering thus used in a variety of ways.

The invention solves the addressed problem by way of a covering system according to the preamble of claim 1, which is characterized in that the at least one conducting element is configured to conduct a physical quantity, a material or signals, at least one conducting element comprising an interface to a source or a consumer of the physical quantity, the material or the signals.

The design of the covering system according to the invention enables the physical quantity, material or signal to be conducted along the covering system to almost every desired point in the floor, wall and/or ceiling: For example, the point at which a consumer for the physical quantity, material or signal to be conducted is arranged. Since the conducting element can be seen from the decorated side of the covering system, it can also be used as a decorative element and is easily accessible. In a preferred embodiment, the conducting element can even be replaced when the covering system has been laid and can be removed from and subsequently re-inserted into the covering system, for example for maintenance or repair purposes. In this case, it is beneficial if the adjacent covering elements, between which the conducting element is arranged, form a slot or a groove in the laid and interconnected state, i.e. generally speaking a depression that can be accessed from the decorated side. The at least one conducting element can be arranged in said depression, so that it can be seen and accessed from the decorated side. As a result, existing covering systems that feature such a depression, groove or slot on their decorated side can be up-graded.

The fact that the at least one conducting element is arranged between the two covering element means particularly that a covering element is arranged on each one of two opposite sides of the conducting element. Specifically, it does not mean that the two covering elements are otherwise not allowed to touch, or that the at least one conducting element is arranged entirely between the two covering elements. It is by all means advantageous if the covering elements, for example panels with a core made of a wood-based material, in particularly MDF, HDF or OSB, have corresponding connecting and/or locking elements. These are preferably designed in such a way that the connecting and/or locking elements of two adjacent covering elements are enough to connect the covering elements to each other and to lock them in relation to each other in as many directions as possible, so that a relative movement of the covering elements locked in this manner is no longer possible.

However, the at least one conducting element can be designed in such a way that it extends across the entire thickness of the covering system, i.e. from the decorated side to the opposite lower side. Preferably, locking and/or connecting elements are arranged on the at least one conducting element, designed corresponding to a locking and/or connecting element on a side surface of a covering element, thereby achieving the connection and/or locking between the covering element and the conducting element. The conducting element may also be designed with locking and/or connecting elements on the opposite side, which is allocated to the other covering element, wherein said elements can be used to position the conducting element on the respective covering element.

In a preferred embodiment, the covering system has at least one connecting element between all covering elements used. In this way, the physical quantity, material or signal can be conducted to almost every point in the floor, wall and/or ceiling that is equipped with the covering system without having to lay complex cabling, pipelines or other elements. Particularly preferably, the covering system features conducting element interfaces, which allow conducting elements to also be arranged between a covering element of a floor and a covering element of a wall, or a covering element of a wall and a covering element of a ceiling. In particular, conducting elements can also extend from a floor to a wall or from a wall to a ceiling. In this way, the entire space can be equipped and supplied with the physical quantity, material or signals.

The at least one conducting element need not be restricted to the transport of a single physical quantity, material or one type of signal. Rather, it refers to all conducting elements that are configured to conduct at least one physical quantity, at least one material and/or at least one type of signal. For example, the at least one conducting element may comprise an electrical conductor or be an electrical conductor, configured on the one hand to conduct electrical energy, i.e. a physical quantity, and on the other to conduct electronic signals, preferably even at the same time. For this purpose, the signals can be modulated onto an AC voltage, for example. Alternatively or additionally, the at least one conducting element is equipped with a pipeline, preferably made of metal. In this way, the conducting element is configured to conduct a liquid, for example water, i.e. a material. If, for example, insulated electrical conductors in the form of individual wires are then arranged in or on the wall of the pipeline, the conducting element is also set up to conduct an electrical current and/or electronic signals.

The covering system preferably has at least two conducting elements, each having corresponding interfaces and being interconnected in such a way that the physical quantity, material or signals can be conducted from one conducting element into an adjacent conducting element. Particularly preferably, at least one part of the conducting elements features interfaces to which three or four conductive elements can be connected. In this way, both “T” crossings and conventional crossings can be created. This is especially advantageous if conducting elements are provided between panel-shaped covering elements along not only one direction, but along two different directions, which are preferably perpendicular to each other.

Preferably, at least one of the conducting elements, but preferably all conducting elements, features a conductor for conducting the physical quantity, material or signals, and a cover layer, the cover layer being arranged in such a way that it can be seen on the decorated side. The actual conductor for conducting the physical quantity, material or signals may be, for example, a cable, in particular a metal cable or a fiber op-tic cable, metal piping, a pipe, a pipeline or a tube. If a decorative effect is to be created by the at least one conducting element that is already achieved by the conductor, it is advantageous if the conducting element does not have a cover layer that co-vers the conductor. However, if a different decorative effect is to be created, the cover layer is an advantage. It can be designed to be decorative and designed almost completely freely in terms of color, material and surface texture.

At least one conductor, but preferably all conductors, is/are preferably connected to a separate interface element, on which an interface for connecting to another conductor is arranged. Such an interface element interconnects two, three or four conductors. Of course, a different number of conductors can be interconnected. This is al-ways practical if the physical quantity, material or signal from one conductor is to be distributed across one or several other conductors. Particularly preferably, interface elements are at least also used and provided that enable two conducting elements to cross without any exchange of physical quantity, material or signals between the two conducting elements. An interface element that renders this possible preferably has at least four ways to be connected to a conductor, creating the different conducting elements, and the physical quantity, material, or signal cannot be transferred from each connected conductor into each connected conductor.

Preferably, several conducting elements feature an interface to a source or a consumer of the physical quantity, material or signals.

Advantageously, the physical quantity is heat or an electrical current. If the conducting elements are configured to transport heat, a targeted distribution of heat can be achieved in the covering system by distributing conducting elements in the covering system as required. If the covering system is, for example, a floor, it is advantageous, for example, to provide the main paths in a room whose floor is equipped with the covering system with more conducting elements than, for example, parts of the covering system located under a cabinet or under a carpet. If the conducting elements are not to be arranged between all covering elements, it is advantageous if the covering elements between which one conducting element is to be arranged are different to those between which no conducting element is to be arranged. Preferably, the covering elements between which a conducting element can be arranged feature the previously described depression, groove or slot in the decorated side when the covering elements are interconnected. Covering elements between which no conducting element is to be arranged preferably do not feature such a depression, groove or slot.

If the physical quantity is an electrical current, it can be used, for example, to be con-verted into heat via an ohmic resistor. In this way, too, underfloor heating can be created. In particular, when using a conducting element to conduct an electrical current, it makes sense to provide a cover layer made of an electrically insulating material to ensure that persons walking on the covering system are not exposed to any danger. Alternatively or additionally, however, the electrical current to be conducted can also be used to supply consumers of the electrical current. This can be any electrical or electronic device that can or must be equipped with a power supply. Such an embodiment of a covering system can render the arrangement of multiple sockets in the walls of a room redundant and, in particular, make it possible to supply several electrical devices with an electrical current in an inconspicuous and/or decoratively ap-pealing manner even if there is not a sufficient number of sockets in the respective room. The use of unsightly, potentially dangerous, power strips can thus be avoided.

Alternatively or additionally, the at least one conducting element is configured to conduct a material. This is preferably a fluid, i.e. a liquid or a gas. The material is preferably a liquid, particularly a heat-conducting liquid, such as a thermal oil. It serves to heat the surface equipped with the covering system and to create underfloor heating, for example. Of course, such a system can also be used to cool a room by using a material with a reduced temperature, particularly a coolant, rather than a heated material.

Alternatively or additionally, the conducting element is configured to conduct electrical, electronic or optical signals. These can be transmitted, for example, from an in-ternet connection, such as a router, to a computer, tablet or other device. In this way, Wi-Fi boosters can be replaced and the data transmission rate simultaneously in-creased, thereby improving the stability of the network. Other electric or electronic signals, which would otherwise require separately laid cables, can also be trans-ported and conducted via the conducting elements.

If the conducting elements comprise a conductor with a separate interface element, the covering system can also be adapted to the respective dimensions of a room to be fitted with the covering system. Both the covering elements and the conducting elements can be cut to the desired length. In this case, the conductor is cut from the conducting element to the desired length and subsequently connected to the separate interface element required in each case.

In a preferred embodiment, an interface element, which can be connected to such a conductor, not only has the capability of interconnecting a plurality of the conductors, but preferably also has an interface for a consumer or source of the physical quantity, material or signals. In this way, the respective consumer can be arranged at almost any point in the floor, wall or ceiling equipped with the covering system and supplied with the physical quantity, material or signals required without inconvenient cables, tubes or pipelines.

Preferably, at least one interface is a power socket, particularly for safety plugs, a LAN socket, a TV or antenna socket, a USB or HDMI socket or an induction coil. All of these interfaces allow an electrical current and/or electrical or electronic signals to be passed from a conducting element or its conductor to a consumer, or from a source to the conducting element or its conductor.

The cover layer is preferably made of an electrically insulating material. Preferably, at least two covering elements are interconnected and preferably interlocked by means of at least one conducting element. In particular, this means that the conducting element features connecting and/or locking elements via which it can be connected and/or locked to both covering elements to be connected.

The at least one conducting element is preferably made of metal, for example copper or iron, and designed in the form of piping. Alternatively or additionally, the conducting element is made of a fiber material, such as carbon fibers or glass fibers. This is particularly beneficial for conducting electrical and/electronic signals as well as optical signals. A connection to a main source, such as a power supply, a data supply or a heat supply, is preferably established at the edge of an installation surface of the covering system. Alternatively or additionally, this connection may also be established, in particular, along a long side of the covering element, preferably designed as a rectangle. A connection on a short side of the covering element is also possible.

Advantageously, the covering system has a control unit, by means of which, for example, the quantity of the material, physical quantity or signals to be conducted can be controlled. The covering system can preferably be connected to heat pumps, hot water heating elements and other low energy installations. Supply points for wireless power transmission can also be arranged in all areas of the covering system, for example in the form of induction coils. For use as a heating element, the conducting element can be made of almost any material that can be electrically heated.

From the prior art, it is known to incorporate carbon fibers into a decorative paper, which can be used as electrically conductive paper in floor panels. This is also described in EP 2 770 104 B1. The design according to the invention allows an electrical contact to be established to these carbon fibers via the at least one conducting element, thereby ensuring a power supply, even in a larger embodiment of the covering system.

In a specific embodiment, the conducting element can be connected to a 220V power supply. In this case, the conducting element is made of material that can be heated with electricity particularly effectively—e.g. a highly heat-emitting carbon strand (carbon fibers), which is coated, for example, with a pollutant-free temperature-resistant silicone. On the decorated side, i.e. at the contact point to ambient air, the carbon strand can be coated with a robust ceramic surface (e.g. PolyVision) for the maxi-mum emission of heat waves. The color, and therefore the decorative effect, can be freely selected. The power supply and thus the room temperature can be regulated via a room thermostat, a transformer or another controller. In areas where contact with people may be possible (e.g. floors), the surface temperature can be regulated by sensors. It preferably switches off at 38° C. If the temperature falls below 25° C. surface temperature, it is switched on again. Furthermore, the surface coat can be made of steel, natural stone or other heat-emitting materials. Towards the bottom, i.e. away from the decorated side, the carbon fiber is preferably very well insulated by the covering element (e.g. wood-based material) and mainly transfers the heat directly to the surface/ambient air. If a room is well insulated, approximately 50 Watt per square meter of heating capacity is required to create a pleasant room temperature. For example, for an apartment of 60 m², approximately 3000 W are required. If the size of the covering element is 140×20 cm, it results in approximately 215 covering elements with some 300 m of conducting elements on the long sides. Corre-spondingly, approximately 10 Watt per meter are required. The cross section of the conducting elements and preferably their conductors can be adjusted accordingly.

In another embodiment, the at least one conducting element is connected to an external heat supply. It is shaped in such a way that heated water (approximately 20-38° C.) flows via a circulation pump out of a heat pump installation/hot water installation into a cavity. In turn, the heated water heats the material of the at least one conducting element, which emits the heat into the ambient air. Preferably, the material of the at least one conducting element is preferably effective at conducting heat in the upper area, i.e. towards the decorated side where contact with the ambient air occurs, and in the direction of the covering elements, i.e. away from the covering elements, made of insulating materials. The through-flow and thus the room temperature can be regulated via room thermostats or other controllers.

In a further embodiment, the at least one conducting element is connected to a 220V power supply. In this case, the material of the at least one conducting element is made of material that conducts an electrical current. The arrangement is executed in such a way that a transmitter coil is created. Consumers that contain receiver coils can be laid/placed on the transmitter coil to inductively transfer energy for charging or consumption. The power supply can be regulated via a transformer or other controllers. This means that power can be safely tapped at specific points within the area covered by the covering system for consumers, such as cell phones, LED lamps, charging stations or other consumers.

In a further embodiment, the at least one conducting element is connected to a 220V power supply. In this case, the material of the at least one conducting element is made of material that conducts an electrical current or electronic data. The power supply can be regulated via a transformer or other controllers. Points of consumption (e.g. mini USB interfaces, power sockets, headphone connections, LAN sockets, TV or antenna sockets) can be integrated at points in the conducting element, for example one per covering element. On the decorated side, these can be protected from external influences, such as moisture, by a cap.

In a further embodiment, the at least one conducting element is connected to a Wi-Fi router. In this case, the material of the conducting element is made of material that can forward signals from a router (e.g. a metal, preferably sheet metal). A coaxial cable is connected at the edge of the surface covered by the covering system, wherein said cable can be connected to the router.

The covering system preferably comprises a source of the physical quantity, material or signals that is connected to the interface. The at least one interface and/or the interfaces of the at least one interface element are preferably designed as form-fitting elements, wherein form-fitting elements are preferably regarded as corresponding if they can form a form-fitting connection with one another.

Two or more adjacent conducting elements can preferably be interconnected. This can be achieved via the separate interface elements described previously or via interface installations integrated into the conducting elements. Here, the conducting elements can be interconnected in such a way that the respective physical quantity and/or material and/or signals can be conducted from one conducting element into an adjacent conducting element. Alternatively, the connection can also be achieved through functional elements. These may be designed as separate components or integrated into the conducting elements.

The functional elements are preferably configured to influence the flow of the physical quantity, material and/or signals. Functional elements can be configured, for example, to interrupt the flow. To this end, they may also be designed as a switch or valve. They can also amplify the flow, for which they may be designed as a pump element or amplifier, for example. The functional elements are preferably interconnected and/or connected to a central control system, for example an electronic data processing device. Particularly preferably, it is configured to control the total flow through the covering system by activating the individual functional elements.

The covering system according to the present invention usually comprises a plurality of covering elements that are interconnected and interlocked. On the decorated side they feature a decoration printed on a layer, for example a core or a decorative paper. Covering systems are also known that additionally include underfloor heating, if necessary with sub-insulation, heating loops and screed concrete or an underfloor heating system that is laid under the covering elements. In all of these embodiments, changing the motif of the decoration is impossible or possible only with considerable effort. Often, the entire covering system would have to be taken up and a new covering system with new decoration laid.

The covering elements therefore preferably comprise a base body and a top layer that is detachably connected to the base body. This design of covering elements is also advantageous independently of the embodiments of the covering system described here so far and forms an independent invention. This relates in particular to covering systems of the type described here that do not feature conducting elements. This independent design thus relates to a covering system for a floor, a wall and/or a ceiling, the covering system comprising a decorated side, a lower side opposite the decorated side and a plurality of interconnected covering elements. Those used in such a covering system or a covering system of the type described thus far feature the base body and the top layer.

Preferably, the top layer of the covering elements can also be detached from the respective base body of the covering elements after the covering system has already been laid.

The base body preferably comprises a core made of a wood-based material, for example an HDF panel or a chipboard panel. Other materials can also be used, such as vinyl, cork, genuine cork or another material. It is preferably equipped with laying profiles to interconnect and interlock adjacent covering elements. The color of the surface of the base body that faces the top layer can be designed in a such a way that it has an impact on the visual design and aesthetic appearance of the covering system. In particular, a standard decoration is preferably already applied to the surface. Advantageous formats are, for example, 25 cm×140 cm, 28 cm×220 cm or 15 cm×50 cm.

The top cover is preferably designed to be transparent for visible light. In this way, a motif or decoration applied to the surface of the base body, for example the standard decoration, is visible through the top layer. The top cover can also be colored and thus be transparent only for a certain color, for example.

Preferably, the top layer has multiple layers that are preferably formed of different materials. It has been proven advantageous if a layer that forms the decorated side of the covering elements has abrasion-resistant properties. For this purpose, addi-tives, for example corundum particles, can be mixed into a plastic or synthetic resin to increase abrasion resistance. Alternatively or additionally, this layer can be made from a abrasion-resistant material, such as macrolon or polycarbonate. Another layer of the top layer which forms the side facing the base body preferably has sound-absorbing properties and, for this purpose, is preferably designed to be softer. For this layer, a silicone or an elastomer can be used, for example.

The top layer preferably has a thickness of at least 0.5 mm, preferably at least 1 mm and at most 5 mm, preferably at most 2 mm. Its surface can be matt or glossy and/or designed with a structure, for example imitation wood grain. Alternatively or additionally, the lower side of the top layer that faces the base body may be engraved or em-bossed, for example, and feature a structure. If the top layer is designed to be transparent, this structure also has a visual impact. A decoration is preferably printed on the lower side of the top layer facing the base body.

In a preferred embodiment, a motif layer is located between the base body and the top layer. This may take the form of a paper layer, for example, with 1 grammage of 50 g/square meter to 100 g/square meter. The motif of the decoration is preferably printed on the paper layer and the paper layer positioned in such a way that the decoration is visible through the top layer when the covering elements are laid.

Particularly preferably, the base body and/or the top layer are designed in such a way that a cavity is formed between them, which is preferably up to 2 mm, preferably up to 1 mm, high. As a result, materials can be arranged between the base body and the top layer to change the aesthetic appearance of the covering elements. These may be sheets, sand or powder, for example. If the motif layer is only relatively thick at certain points, it is advantageous to use compensation elements that are positioned between the individual decorative elements, which are arranged between the base body and the top layer. A large variety of decorative elements, such as photo-graphs, collages or other elements such as real wood veneers, can be inserted into the cavity.

The layer or side of the top layer facing the base body is preferably designed to com-pensate any differences in height and/or unevenness caused, for example, by decorative elements arranged between the base body and the top layer.

In a preferred embodiment, the top layer is connected to the base body via a form-fitting connection, preferably a snap-on connection. Particularly preferably, the snap-on elements extend around the circumference of the base body and the top layer. The connection can preferably be released, for example, by a vacuum, i.e. a suction effect, or by mechanical influence. Alternatively or additionally, magnetic particles may be provided in the base body and/or the top layer. In this case, it is enough for magnetic particles to be present in the base body or the top layer and magnetizable particles to be present in the respective other element, i.e. the top layer or the base body. The magnetic and/or magnetizable particles can be distributed homogeneously across the surfaces or arranged inhomogeneously, for example in the edge regions.

Particularly preferably, the connection between the top layer and the base body is designed in such a way that it seals the space between the top layer and the base body against the penetration of dust and/or liquids. To this end, the edge of the top layer, i.e. its edge region, and/or that of the base body can be coated with an elastomer or another sealing material, for example.

The use of covering elements with a base body and a top layer renders it possible, for example, to achieve a change of motif of a covering system laid on the floor, as shown with the aid of an example: First, covering elements are laid that comprise a base body with a core made of an HDF panel. The base body measures 25 cm×180 cm and has a thickness of 10 mm. The base bodies can already be additionally coated with an impregnated decorative paper, for example a walnut decoration and a protective layer, as required. The base bodies are profiled around their circumference to allow connection to other panels in a covering area. This profiling includes a cir-cumferential notch or slot, which allows the attachment and removal of the top layer. 42 m² of these panels are laid in a living room. The walnut decoration already pro-cessed by the manufacturer can be seen through the top layer.

The owner may wish to change the motif after a year and opt for a replacement decoration directly from the manufacturer. To this end, ready-cut decorative paper suitable for these covering elements is used. The top layers of the panels are removed with suitable accessories, for example by subjecting the decorated side to a negative pressure. The new decorative paper webs, which feature a chestnut motif, for example, are then positioned directly on the base bodies and attached. Once the motif has been replaced in the entire covering system, it becomes clear that the wrong decorative paper has been used for some covering elements; these can be replaced with others. It is thus possible to replace the decoration fully or partially after a desired pe-riod of time.

With a covering system in which all or at least some of the covering elements have a base body and a top layer that is detachably arranged on said base body, a so-called mixed installation can also be created. Such covering elements are also referred to as motif-flexible covering elements. For example, a covering system is laid in a room, for example, laminate flooring with beech decoration in 10 mm thickness. Within this area, some motif-flexible covering elements are laid in the same thickness and with the same connection method. Now these can be filled individually, for example, with self-created pictures and graphics.

A new partitioning of an existing room is also to achieve with these covering systems, which will be illustrated by the following example. Motif-flexible covering elements with walnut decoration have been laid in a 74 m² living room. After 2 years, the space is repartitioned and a 23 m² play area integrated into it. In order to visually distinguish the latter, the walnut motif in this area is replaced by a child-friendly decoration.

However, it is not only possible to change the motif of the covering element through motif-flexible covering elements. If the tread surface has become unsightly in one area of the laid covering system, for example due to wear, the top layer in this area can be removed from the individual layer elements and replaced by a new top layer that can be designed to be identical.

In the event that, for example, a technical configuration of a room is to be replaced or supplemented, the covering systems described here are also beneficial. This will be explained in the following example: a new heating system is to be installed in an old building with 3.70 m-high ceilings which will get its energy from renewable sources.

The owner of the building lays a motif-flexible covering system, the covering elements of which are designed in a 20 cm×140 cm format. The covering system features conducting elements that are laid at a joint on the long side of the covering elements. The conducting elements are configured to conduct hot water with a flow temperature of 38° C. out of a heat pump via a cross-sectional surface of 0.5 cm². The building owner's heat pump is supplied via a borehole heat exchanger and solar power. The hot water distribution of the heating circuits occurs via supply lines and reversing loops in the baseboard area. As the heat dissipation in winter is not sufficient when outside temperatures are below −5 C°, the covering elements are further equipped with 5 additional hot water pipes each in the core of the base body in a direction parallel to the long side. Each of these also has a cross-sectional surface area of 0.5 cm². These additional hot water pipes increase the available heating power by 500% when required. Each room has a thermostat for regulating the room temperature. The decoration can still be changed by means of the removable top layer.

According to another example, covering elements in a 25 cm×186 cm format are laid in a room. First of all, those of the base bodies are laid completely. The surfaces of the base bodies that face the top layer have each been milled out by half the cross section of the conducting element and holes at regular intervals of 20 cm. Fastening points in the form of hooks are fixed on the conducting element, which is inserted into the resulting slot, at regular intervals of 20 cm in the direction of the base body and the top layer, the hooks being 4 mm long. The hooks of the conducting elements are first locked into the base body. The top layer of the base body is then locked onto the hooks of the line, thereby creating a secure connection of the panels in the direction of the conducting elements.

In this case, the conducting element in the form of piping, which is made of metal and configured to transport a Wi-Fi signal, also features hooks on the side and at regular intervals, which lock the covering elements in the direction of the piping on the long side.

Preferably, at least some, but preferably all, of the covering elements of the covering system are designed with underfloor heating. This underfloor heating features lines through which a heat transfer medium is conducted to give off heat to the covering elements, which are preferably floor elements, thereby heating a room, for example.

In a first embodiment of this underfloor heating, the bores required for the lines are introduced into the base body of the covering elements, for example drilled or milled. This is an option both for embodiments of the covering system that feature a base body and a top layer, and embodiments where the conducting elements described are located between the individual covering elements. Of course, underfloor heating is also possible with covering systems where the covering elements feature a base body and top layer and conducting elements are arranged between individual or all covering elements.

Alternatively or additionally, the lines required for underfloor heating can also be arranged between the base body and the top layer. In this case, cross sections or partial cross sections are introduced, for example drilled or milled, into the side of the base body facing the top layer and/or in the side of the top layer facing the base body. When top layer and base body are at a later point brought together and fixed to each other, it results in the required cross sections. First of all, the lines are preferably inserted and fixed in the introduced cross sections. The lines may be designed, for example, as pipelines, for example copper pipes, and are preferably made of a material that has a high thermal conductivity. The lines are preferably fixed, for example stuck, to the base body or the top layer. Alternatively or additionally, bracket holes can be introduced, for example drilled or milled, into the base body or the top layer, into which bracket elements, which are preferably arranged on the lines, are introduced. This results in a secure connection between the lines and the base body or top layer. Once the lines have been fixed to the base body or the top layer, the respective other component is fixed, i.e. the top layer or the base body. This may be achieved in a non-detachable manner, for example through sticking them together, or in a detachable manner through plug-in or clip connections or in another form-fitting manner.

For example, if such a covering system is to be laid on a floor, in this construction the base bodies of the covering elements can be laid first. The lines for the entire covering system are then laid and fixed to the base bodies before arranging the top layers and, where applicable, the conducting elements provided.

Alternative lines can also be provided in a different form: for example, they can designed to be not in the form of pipes. In this way, it is preferably possible to design the lines in such a way that they correspond completely or almost completely to the panel surface, so that the covering system installed preferably gives off thermal energy across its entire surface area. This allows for an especially homogeneous temperature across, for example, a tread surface of the covering system which people can walk on. The assembly of such a system can be done according to the method described above.

Thanks to the 2-part design of base body and top layer, it is possible to use different materials that, in particular, exhibit a different thermal conductivity. While the base body is made of or produced from a material with a low heating capacity and/or low thermal conductivity, for example, it is beneficial if the top layer is produced from a material with the highest possible thermal conductivity. The same applies for other physical properties, such as sound insulation, which can be designed differently in different areas of the covering system later installed.

The embodiments with underfloor heating are of particular significance for buildings with a heating system that is fitted with low-temperature systems, such as heat pumps. They are very similar to conventional underfloor heating, but are considerably quicker, easier and therefore cheaper to lay, and to maintain and repair. As such, it is possible to heat a room either with or without conducting elements in such a way that a pleasant interior temperature is achieved. The combination with the removable top layer results in further combination options and advantages regarding maintenance and repair, and if a decoration or visual appearance of the floor is to be changed.

### BRIEF DESCRIPTION OF DRAWINGS

In the following, a number of embodiment examples of the invention will be explained in more detail with the aid of the accompanying drawings. They show

FIG. 1 shows a schematic top view of a covering system according to a first embodiment example of the present invention,

FIG. 2 shows a schematic top view of a covering system according to a second embodiment example of the present invention,

FIG. 3 shows a schematic sectional view through two connected covering elements,

FIG. 4 shows a schematic sectional view through two connected covering elements and an individual covering element, and

FIG. 5 shows a schematic sectional views through covering elements with differently designed underfloor heating.

### DETAILED DESCRIPTION

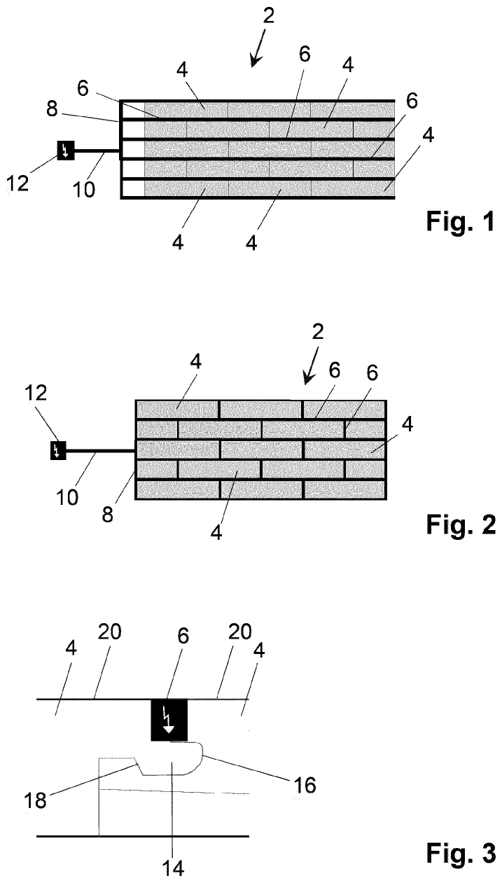

FIG. 1 depicts a schematic top view of a covering system 2 according to a first embodiment example of the present invention. It comprises a plurality of covering elements 4 in the form of floor panels. These are designed to be rectangular and have two long sides and two short sides. Along the long sides are conducting elements 6 that are arranged parallel to one another and shown by way of bold lines. The various conducting elements 6 are interconnected along a front side 8 of the surface covered by the covering system 2, which is also shown by a bold line. At this point there is also an interface 10 to a central power supply 12.

FIG. 2 depicts a similar view. The individual covering elements 4 are arranged in rows and have long sides and short sides. Unlike in FIG. 1, however, conducting elements 6 are also provided along the short sides, said elements all being interconnected. Each conducting element 6 is connected to a central power supply 12 via the interface 10.

FIG. 3 shows a cut through 2 connected covering elements 4: the left-hand covering element 4 features a spring 14, which is inserted into a specially provided slot 16 of the right-hand covering element 4. Together, they also form locking elements 18 that prevent the two covering elements 4 from inadvertently becoming detached from each other. On the decorated side 20 of the two covering elements 4, the conducting element 6 is situated between the two covering elements 4, the conducting element conducting an electrical current in the example embodiment shown.

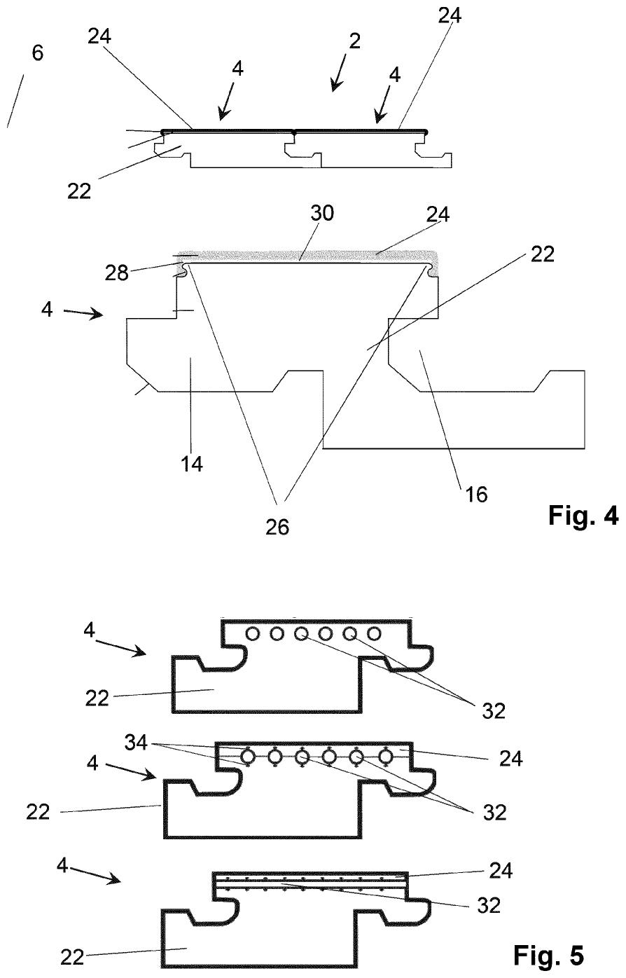

FIG. 4 shows a covering system 2. The upper area of FIG. 4 shows two interconnected covering elements 4, each of which comprises a base body 22 and a top layer 24 arranged thereon. In the lower part of FIG. 4, an enlarged view of one of the covering elements 4 is schematically depicted. The base body 22 comprises the spring 14 on the one side and the slot 16 on the opposite side. By way of this locking, two adjacent covering elements 4 of the same design are interconnected and interlocked. The top layer 24 is positioned on the base body 22 via form-fitting elements. For this purpose, the base body has latches 26, which engage in the undercuts 28 of the cover layer 24. This results in a form-fitting connection between the base body 22 and the top layer 24. Between the top layer 24 and the base body 22 is a cavity 30, in which decorative elements can be arranged.

FIG. 5 shows three sections through a covering element 4, each of which has lines 32 for underfloor heating. In the top of the 3 embodiment examples, the lines 32 are arranged in bores in the base body 22, which is designed as a single piece. In the middle representation, the respective covering element 4 has a base body 22 and a top layer 24, between which the lines 32 are positioned. A partial cross section of the lines 32 is incorporated in both the base body 22 and the top layer 24. It should be acknowledged that bracket elements 34 are also provided, which engage in bores provided for this purpose in the base body 22 and in the top layer 24. In the lower illustration of the top layer 4, the line 32 is also located between the base body 22 and the top layer 24; however, it is not designed to be tubular, but rather as a flat object.

1. A covering system for a floor, a wall and/or a ceiling, the covering system comprising:
a decorated side,
a lower side opposite the decorated side and
a plurality of interconnected covering elements,
wherein at least one conducting element is arranged between at least two of the covering elements in such a way that the at least one conducting element is at least partially visible on the decorated side, and the at least one conducting element is configured to conduct a physical quantity, material or signals, and the at least one conducting element comprising an interface to a source or a consumer of the physical quantity, material or signals.

2. The covering system according to claim 1, wherein the covering system comprises at least two conducting elements, each having corresponding interfaces and being interconnected in such a way that the physical quantity, material or signals can be conducted from one conducting element into an adjacent conducting element.

3. The covering system according to claim 1, wherein the at least one conducting element comprises a conductor for conducting the physical quantity, material or signals, and a cover layer, the cover layer being arranged in such a way that it can be seen on the decorated side.

4. The covering system according to claim 1, wherein the at least one conducting element is connected to a separate interface element, on which an interface is arranged for connecting to another conductor.

5. The covering system according to claim 1, wherein the at least one conducting element comprises several conducting elements and each feature an interface to a source or a consumer of the physical quantity, material or signals.

6. The covering system according to claim 1, wherein the physical quantity is heat or an electrical current, or that the material is a fluid, including a liquid, or that the signals are electrical, electronic or optical signals.

7. The covering system according to claim 1, wherein the at least one interface is a power socket, including for a shockproof socket, a LAN socket, a TV or antenna socket, a USB or HMDI socket, or an induction coil.

8. The covering system according to claim 3, wherein the cover layer is an electrically insulating material.

9. The covering system according to claim 1, wherein the at least two covering elements are interconnected and interlocked by at least one conducting element.

10. The covering system according to claim 1, wherein a source of the physical quantity, material or signals that is connected to the interface.

11. A covering system for a floor, a wall and/or a ceiling, the covering system comprising:
a decorated side,
a lower side opposite the decorated side, and
a plurality of interconnected covering elements, or at least one covering element, comprises a base body and a top layer arranged thereon.

12. The covering system according to claim 11, wherein the top layer comprises a material that is transparent for visible light.

13. The covering system according to claim 11, wherein the top layer comprises an abrasion-resistant layer made of macrolon or polycarbonate, or a layer equipped with abrasion-resistant particles, including corundum.

14. The covering system according to claim 13, wherein the layer facing the base body comprises a noise-absorbing layer.

15. The covering system according to claim 11, further comprising a cavity between the base body and the top layer.

16. The covering system according to claim 15, wherein at least one decorative element is located in the cavity.

17. The covering system according to claim 11, wherein a decoration is printed on a surface of the base body facing the top layer.

18. The covering system according to claim 11, wherein the base body and/or the top layer comprises a sealing element by means of which the cavity is sealed.

19. The covering system according to claim 16, wherein the least one decorative element comprises a decorative paper.

20. The covering system according to claim 11, wherein the at least one covering element is multiple cover elements each of which comprise the base body and the top layer arranged thereon.
